(19) United States
(12) Patent Application Publication
(10) Pub. No.: US 2017/0283167 A1
(43) Pub. Date: Oct. 5, 2017

(54) VEHICLE TRASH DISPOSAL SYSTEM

(71) Applicant: Johnny Michel KHOURY, Al Metn (LB)

(72) Inventor: Johnny Michel KHOURY, Al Metn (LB)

(21) Appl. No.: 15/088,415

(22) Filed: Apr. 1, 2016

(51) Int. Cl. B65F 1/00; B65F 1/14; B65F 1/06

(52) U.S. Cl. CPC B65F 1/0013; B65F 1/002; B65F 1/0053; B65F 1/067; B65F 1/1415; B65F 2001/061; B65F 2001/1676

(57) ABSTRACT

The present invention relates to a vehicle trash disposal system used for storing vehicle trash in a simple and effective manner. The system consists of an outer permanent bag having magnetic sealing strips on the top part and an inner trash bag that is releasably connected to the outer permanent bag. The magnetic strips on the top part of the outer permanent bag ensure that any trash inside the inner trash bag are kept out of sight and release minimal odor due to the sealing action of the strips. The system can also be built into a car seat wherein a drawer slides into and out of the car seat. The drawer holds a removable trash receptacle to hold vehicle trash. In addition, the system is ergonomic in that it allows for easy opening and closing even during driving.

### BACKGROUND

### Field of the Invention

The present invention relates to a vehicle trash disposal system for storing vehicle trash in a simple and effective manner.

### Description of the Related Art

The use of vehicle trash disposal systems and devices is well known in the prior art. For instance, numerous patents and patent applications disclose various vehicle trash collection devices and systems used to provide storage for vehicle trash.

As an example, U.S. Pat. No. 5,362,153 provides a litter bag for automobiles and in particular one including a body portion provided at the lower portion with a pocket and on the outer surface with a zipper through which a roll of plastic bags may be disposed therein. The top of the pocket has an elongated slit through which the plastic bag may be conveniently drawn out for use. The bottom of the body portion has a strap designed to fix the body portion under a seat. The upper edges of the body portion has a resilient member in the interior for keeping the mouth of the plastic bag closed normally and a male connector on both ends. The body portion is further provided on both sides with a side flap having on both ends a female connector engage able with the male connector.

U.S. Pat. No. 8,376,200 discloses a trash collector for vehicles in which trash produced in the vehicles are collected and processed neatly and efficiently. The trash collector includes: a body having a space for containing trash and an opening portion; a fixing clip which is detachably installed on an inner side surface of the body; and a roll of vinyl bags which are hung on the hanging portions of the fixing clip and are successively supplied downwards in the body. Here, shield wings are formed on the inner side surface of the body and are inserted into the roll of vinyl bags to thus prevent trash from being exposed. A plurality of leaf springs extend along the opening portion, to enable the space of the body to be maintained at an opened state and with an elastic force, if flexural strengths of the leaf springs exceed threshold points of the leaf springs.

US 2012/0087600 disclose a waste receptacle for installation inside a car and on the back of passenger or driver car seat to allow all passengers to dump in their trash. It comprises three parts, a) Lower Frame which fixes by headrest and always is in place and holds trash bag, b) Upper Lid which is an open top lid and entangles trash bag and c) Disposable Trash Bag which is are cycled plastic grocery bag or any kind of small trash bag. When the trash bag becomes full of garbage, the Upper Lid will be raised by removing it from Lower Frame and trash bag gets out from underside and a new trash bag will be replaced.

None of the prior art documents provide a vehicle trash disposal system that employs and outer permanent bag (or drawer) and an inner trash bag (or trash receptacle) to provide for a simple, neat and effective vehicle trash disposal system.

### SUMMARY

Therefore, it is an object of the present invention to provide a vehicle trash disposal system that is adapted to be either built-in or added-on to the vehicle, simple to operate and customizable to adapt to all vehicle shapes and sizes and does not have to be dismantled to empty the trash.

It is another object of the present invention to provide a vehicle trash disposal system that is compact and does not affect the vehicle's interior legroom or roominess.

As an aspect of the present invention, there is provided a vehicle trash disposal system that is efficient and seals trash contained therein from the vehicle environment and allows the driver to dispose of trash even while driving.

In another aspect of the present invention, there is provided a vehicle trash disposal system that prevent odors of trash contained therein from contaminating the vehicle environment.

As another aspect of the present invention, there is provided a vehicle trash disposal system that keeps out of sight trash disposed therein.

As another aspect of the present invention, there is provided a vehicle trash disposal system comprising essentially of an outer permanent bag having magnetic sealing strips on the top part and an inner trash bag that is releasably connected to the outer permanent bag. The magnetic strips on the top part of the permanent bag ensure that any trash inside the inner trash bag is kept out of sight and releases minimal odor due to the sealing action of the strips.

As another aspect of the present invention, there is provided a vehicle trash disposal system comprising essentially of an outer permanent bag having magnetic sealing strips on the top part and a plurality of inner trash bags that are releasably connected to the outer permanent bag. Each inner trash bag is intended to receive a specific type of trash so as to aid in recycling efforts once an inner trash bag is emptied. The magnetic strips on the top part of the permanent bag ensure that any trash inside the inner trash bags is kept out of sight and releases minimal odor due to the sealing action of the strips.

As another aspect of the present invention, there is provided a vehicle trash disposal system that is opened by the user by means of a tab attached to an outer surface of the outer permanent bag and closed by pushing the outer surface so that the magnetic strips sealably close the outer permanent bag.

Preferably, said inner trash bag is connected to the outer permanent bag by means of buttons.

Preferably, the outer permanent bag is connected to a car seat by means of adjustable strings, belts or both strings and belts.

As another aspect of the present invention, there is provided a vehicle trash disposal system comprising a drawer that slides into a car seat between an open position and a closed position; a trash receptacle removably situated inside the drawer; means connected to the drawer in order to open and close the drawer; wherein the drawer completely seals the trash receptacle from the vehicle environment when in the closed position.

### BRIEF DESCRIPTION OF THE DRAWINGS

The invention will be described with reference to the accompanying drawings, which illustrate preferred embodiments of the present invention without restricting the scope of the invention thereof, and in which:

FIG. 1 is a perspective view of a vehicle trash disposal system according to a preferred embodiment of the present invention;

FIG. 2 is a front view of a vehicle trash disposal system according to a preferred embodiment of the present invention;

FIG. 3 is a back view of a vehicle trash disposal system according to a preferred embodiment of the present invention;

FIG. 3a is a cross-sectional view of a vehicle trash disposal system according to a preferred embodiment of the present invention;

FIG. 4 is a side view of a vehicle trash disposal system according to a preferred embodiment of the present invention;

FIG. 4a is a cross-sectional view of a vehicle trash disposal system according to a preferred embodiment of the present invention;

FIG. 4b is a cross-sectional view of a vehicle trash disposal system according to a preferred embodiment of the present invention;

FIG. 5 is a perspective view of a vehicle trash disposal system according to another preferred embodiment of the present invention in an open position;

FIG. 6 is a perspective view of a vehicle trash disposal system according to another preferred embodiment of the present invention in a closed position

### DETAILED DESCRIPTION

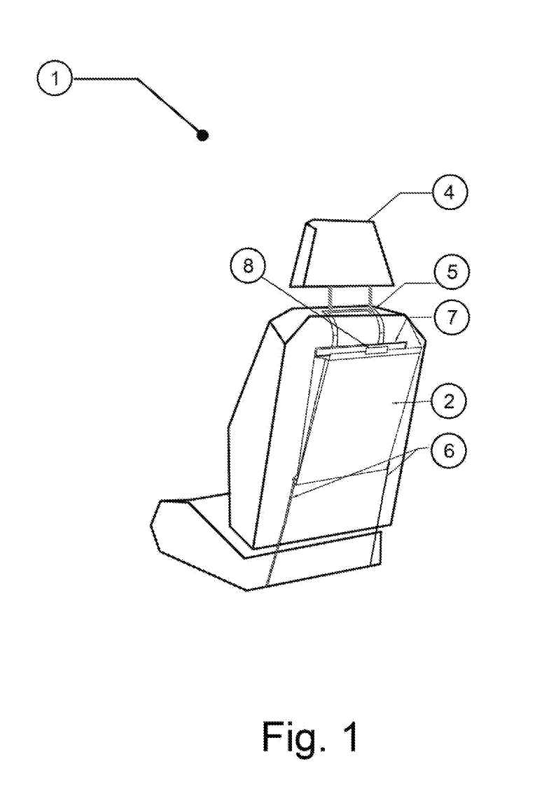

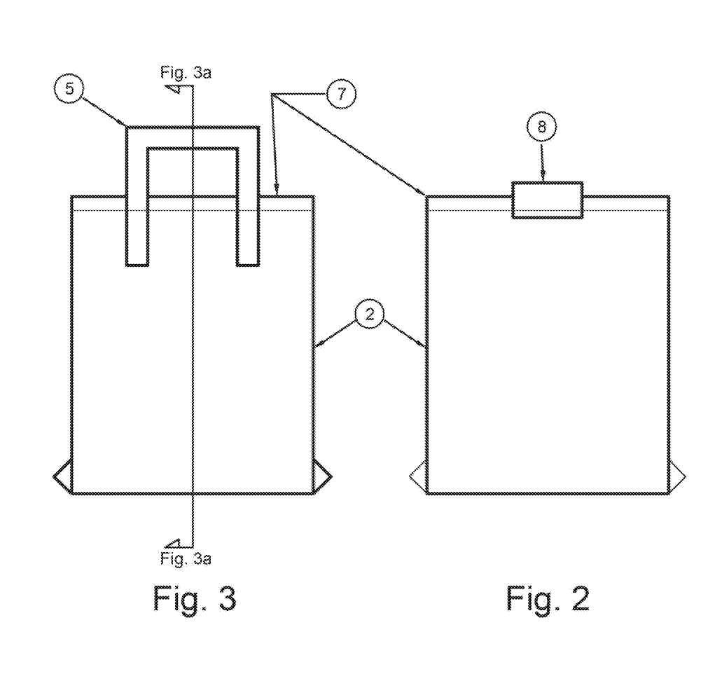

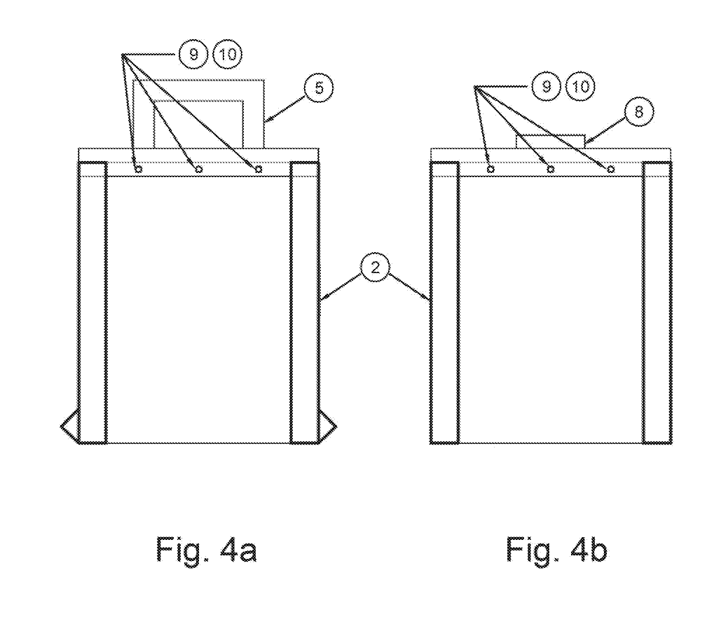

FIGS. 1-4 illustrate a vehicle trash disposal system 1 used for storing trash of a vehicle, configured according to a preferred embodiment of the present invention.

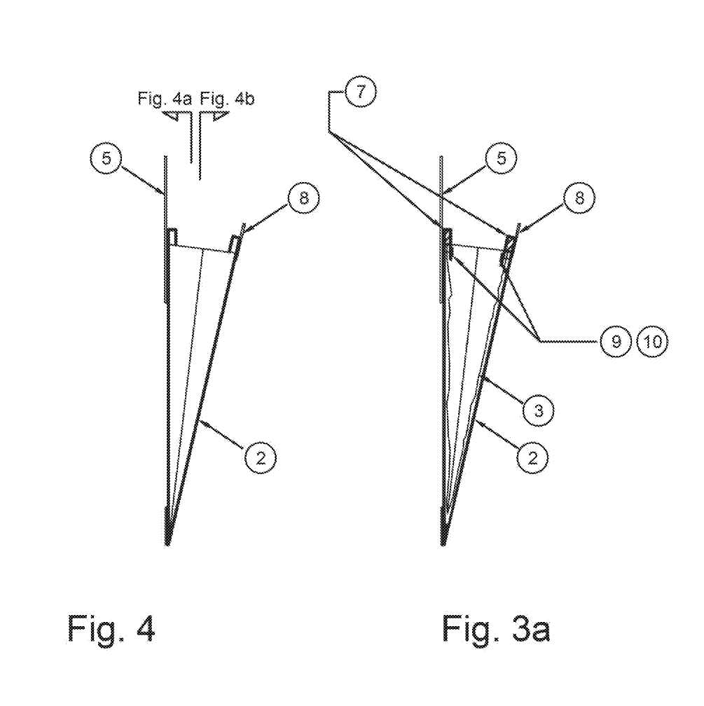

With reference to FIGS. 1-4, the vehicle trash disposal system 1 comprises an outer permanent bag 2 and an inner trash bag 3 (see FIG. 3a) releasably attached to the outer permanent bag 2.The outer permanent bag 2 is preferably aesthetic, and conforming to the car. The outer permanent bag 2 can be made from any suitable material or color. It could also be a designer bag. The exposed side of the outer permanent bag 2 can be used to display any picture, image, map or commercial.

In the preferred embodiment, the outer permanent bag 2 is releasably connected to a car seat 4 by means of a top adjustable connection 5 and a bottom adjustable connection 6. The top adjustable connection 5 connects to a top portion of the car seat 4 and the bottom adjustable connection 6 connects to a bottom portion of the car seat 4. The top adjustable connection 5 can either be a string type connection or a belt type connection. Similarly, the bottom adjustable connection 6 can either be a string type connection or a belt type connection.

With reference to FIG. 3a, a pair of opposing magnetic strips 7 are attached to the opposing inner portions of the top periphery of the outer permanent bag 2. The outer permanent bag 2 can be made from any suitable material such as cloth, paper, plastic, etc . . . .

An opening tab 8 is used to open the outer permanent bag 2. Closing the outer permanent bag 2 is carried out by gently pushing one wall of the outer permanent bag 2 against the opposing wall. The inner trash bag 3 is releasably connected to the outer permanent bag 2 by means of snap buttons 9 or any other simple means to make use of ordinary grocery plastic or paper bags that are readily available to the owner. In another embodiment, plastic attachments 10 can be used to releasably connect the outer permanent bag 2 to the inner trash bag 3. The plastic attachments 10 can be for example hooks that penetrate the inner disposable trash bag 3 allowing the hooks to hold the inner trash bag 3 in place. The inner disposable trash bag 3 can be a commercially available trash bag. Alternatively, the inner disposable trash bag can be a reusable/washable custom fitting inner bag.

In a preferred embodiment, the vehicle trash disposal system 1 typically operates as follows: a user opens the outer permanent bag 2 by pulling the opening tab 8 and drops a piece of trash inside the inner trash bag 3. The user then sealably closes the bag by pushing gently on one wall of the outer permanent bag 2 against the opposing wall. The closing effort is reduced to a minimum due to the magnetic attraction between the magnetic strips 7. Once the inner trash bag 3 is full, the user detaches the inner disposable trash bag 3 by temporarily removing the snap buttons 9 or the plastic attachments 10 and inserts an empty inner trash bag 3.

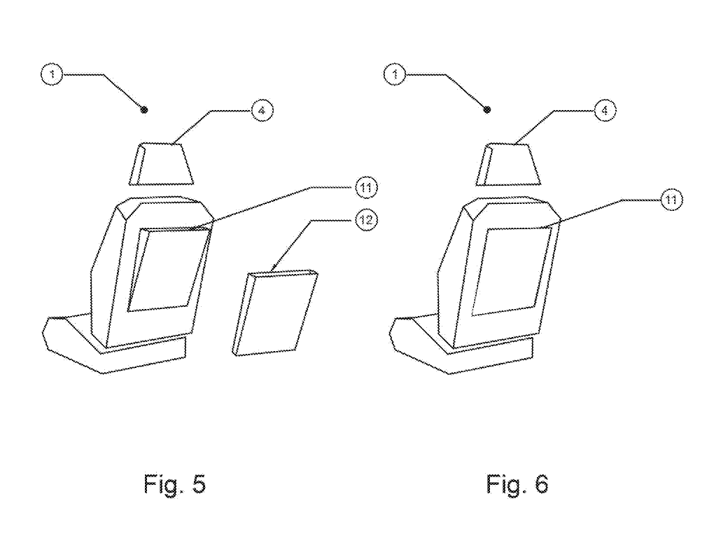

In another preferred embodiment, and with reference to FIG. 5, the vehicle trash disposal system 1 typically operates as follows: a user opens a drawer 11 and drops a piece of trash inside a trash receptacle 12. The user then slides the drawer 11 into the car seat 4. Once the trash receptacle 12 is full, the user removes the trash receptacle 12, empties it, cleans it if necessary and returns it to the drawer 11. Opening the drawer 11 can be done manually by means of a simple handle attached to the drawer 11 or by means of a motor controlled mechanism wherein the driver or one of the passengers operates a simple control module connected to the motor control mechanism to open and close the drawer 11. The drawer 11 and trash receptacle 12 can be made from any suitable material such as metal, plastic or combinations thereof.

The vehicle trash disposal system 1 disclosed in the present application is simple in its construction, effective in sealing and hiding trash and makes use of widely available grocery plastic or paper bags thus making it very economical.

Although the above description contains many specificities, these should not be construed as limitations on the scope of the invention but is merely representative of the presently preferred embodiments of this invention. The embodiment(s) of the invention described above is(are) intended to be exemplary only. The scope of the invention is therefore intended to be limited solely by the scope of the appended claims.

1. A vehicle trash disposal system for installation in vehicles, comprising:
an outer permanent bag;
an inner trash bag releasably connected to the outer permanent bag;
an opening tab attached to the outer permanent bag;
a pair of magnetic strips attached to two inner opposing portions of the outer permanent bag, the outer permanent bag completely sealing the inner trash bag from the vehicle environment when in the closed position;
means for releasably attaching the outer permanent bag to a car seat.

2. The system of claim 1, wherein the outer permanent bag is made from one of plastic, paper, cloth and combinations thereof.

3. The system of claim 1, wherein the inner trash bag is a recyclable grocery bag.

4. The system of claim 1, wherein the inner trash bag is releasably connected to the outer permanent bag by means of snap buttons or plastic attachments.

5. The system of claim 1, wherein the means for releasably attaching the outer permanent bag to the car seat is one of adjustable strings, belts and combinations thereof.

6. The system of claim 1 wherein the means for releasably attaching the outer permanent bag to the car seat consists of a top adjustable connection of the outer permanent bag that connects to a top portion of the car seat and a bottom adjustable connection of the outer permanent bag that connects to a bottom portion of the car seat.

7. The system of claim 6 wherein the top adjustable connection is a belt type connection and the bottom adjustable connection is a string type connection.

8. A vehicle trash disposal system for installation in vehicles, comprising:
an outer permanent bag;
a plurality of inner trash bags wherein each inner trash bag is releasably connected to the outer permanent bag and intended to hold a specific type of vehicle trash;
an opening tab attached to the outer permanent bag;
a pair of magnetic strips attached to two inner opposing portions of the outer permanent bag, the outer permanent bag completely sealing the inner trash bag from the vehicle environment when in the closed position;
means for releasably attaching the outer permanent bag to a car seat

9. The system of claim 8 wherein the outer permanent bag is made from one of plastic, paper, cloth and combinations thereof.

10. The system of claim 8, wherein the inner trash bags are recyclable grocery bags.

11. The system of claim 8, wherein the inner trash bags are releasably connected to the outer permanent bag by means of snap buttons or plastic attachments.

12. The system of claim 8, wherein the means for releasably attaching the outer permanent bag to the car seat is one of adjustable strings, belts and combinations thereof.

13. The system of claim 8, wherein the means for releasably attaching the outer permanent bag to the car seat consists of a top adjustable connection of the outer permanent bag that connects to a top portion of the car seat and a bottom adjustable connection of the outer permanent bag that connects to a bottom portion of the car seat.

14. The system of claim 13, wherein the top adjustable connection is a belt type connection and the bottom adjustable connection is a string type connection.

15-19. (canceled)
